(19) United States
(12) Patent Application Publication
(10) Pub. No.: US 2026/0310525 A1
(43) Pub. Date: Oct. 8, 2026

(54) Safe Dynamically Generated Large Language Model Tool Calling

(71) Applicant: International Business Machines Corporation, Armonk, NY (US)

(72) Inventors: Arn Hyndman, Ottawa (CA); Nicholas Sauriol, Ottawa (CA); John Christopher Lynk, Kanata (CA)

(21) Appl. No.: 19/098,747

(22) Filed: Apr. 2, 2025

(51) Int. Cl. G06F 9/54

(52) U.S. Cl. CPC G06F 9/54

(57) ABSTRACT

Managing LLM tool calling is provided. An API specification corresponding to a specific API endpoint and method extracted from a best matching API to achieve a goal of a user query is retrieved. An API document that supports the API specification corresponding to the specific API endpoint and method to achieve the goal of the user query is retrieved. A tool for an LLM is generated to perform LLM tool calling based on the API specification corresponding to the specific API endpoint and method to achieve the goal of the user query and the API document that supports the API specification. The tool is invoked using the LLM to generate an API call corresponding to the best matching API to achieve the goal of the user query.

### BACKGROUND

The disclosure relates generally to Large Language Models and more specifically to Large Language Model tool calling.

Large Language Models (LLMs) are a category of foundation models trained on vast amounts of data making the LLMs capable of understanding and generating natural language and other types of content to perform a wide range of tasks. LLMs have many parameters, and are trained with self-supervised learning on the vast amount of data. LLMs can be fine-tuned for specific tasks or guided by prompt engineering. Prompt engineering structures an instruction to produce the best possible output from an LLM. A prompt describes the specific task that the LLM is to perform. However, there are certain tasks that cannot be performed by an LLM, at least not without the use of external tools. External tools extend the performance capabilities of LLMs.

### SUMMARY

According to one illustrative embodiment, a method is provided. A computer retrieves an Application Programming Interface (API) specification corresponding to a specific API endpoint and method extracted from a best matching API to achieve a goal of a user query. The computer retrieves an API document that supports the API specification corresponding to the specific API endpoint and method to achieve the goal of the user query. The computer generates a tool for a Large Language Model (LLM) to perform LLM tool calling based on the API specification corresponding to the specific API endpoint and method to achieve the goal of the user query and the API document that supports the API specification. The computer, using the LLM, invokes the tool to generate an API call corresponding to the best matching API to achieve the goal of the user query. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of an LLM tool calling management system in accordance with an illustrative embodiment;

FIGS. 3A-3C are a flowchart illustrating a process for managing LLM tool calling in accordance with an illustrative embodiment; and

FIGS. 4A-4C are a flowchart illustrating a process for performing Application Programming Interface (API) call safety checks in accordance with an illustrative embodiment.

### DETAILED DESCRIPTION

A computer retrieves an Application Programming Interface (API) specification corresponding to a specific API endpoint and method extracted from a best matching API to achieve a goal of a user query. The computer retrieves an API document that supports the API specification corresponding to the specific API endpoint and method to achieve the goal of the user query. The computer generates a tool for a Large Language Model (LLM) to perform LLM tool calling based on the API specification corresponding to the specific API endpoint and method to achieve the goal of the user query and the API document that supports the API specification. The computer, using the LLM, invokes the tool to generate an API call corresponding to the best matching API to achieve the goal of the user query. As a result, illustrative embodiments provide a technical effect of generating a tool for an LLM to perform LLM tool calling based on an API specification corresponding to a specific API endpoint and method to achieve a goal of a user query and an API document that supports the API specification, and invoking the tool to generate an API call corresponding to a best matching API to achieve the goal of the user query using the LLM.

In addition, the computer removes authentication information and other confidential information from the API specification corresponding to the specific API endpoint and method to achieve the goal of the user query to hide the authentication information from the LLM to increase security. As a result, illustrative embodiments provide a technical effect of hiding authentication information from an LLM to increase security by removing the authentication information and other confidential information from an API specification corresponding to a specific API endpoint and method to achieve a goal of a user query.

Further, the computer performs an API call safety check of the API call for the best matching API to achieve the goal of the user query. The computer determines whether the API call safety check indicates that the API call for the best matching API is safe to perform. In response to the computer determining that the API call safety check does indicate that the API call for the best matching API is safe to perform, the computer augments the API call for the best matching API with the authentication information previously removed from the API specification. The computer executes the tool to perform the API call with the authentication information augmented to call the best matching API to achieve the goal of the user query by retrieving needed information from a remote host device containing the needed information. As a result, illustrative embodiments provide a technical effect of augmenting an API call for a best matching API with authentication information previously removed from an API specification in response to determining that an API call safety check indicates that the API call is safe to perform and executing a tool to perform the API call with the authentication information to call the best matching API to achieve a goal of a user query.

Furthermore, the computer receives the needed information corresponding to the goal of the user query from the remote host device in response to executing the API call to the best matching API. The computer filters the needed information corresponding to the goal of the user query received from the remote host device by removing any protected sensitive data from the needed information. The computer sends the needed information corresponding to the goal of the user query with the protected sensitive data removed to a client device user. As a result, illustrative embodiments provide a technical effect of receiving needed information corresponding to a goal of a user query from a remote host device in response to executing an API call to a best matching API, filtering the needed information corresponding to the goal of the user query by removing any protected sensitive data from the needed information, and sending the needed information corresponding to the goal of the user query with the protected sensitive data removed to a client device user.

Moreover, in response to the computer determining that the API call safety check does not indicate that the API call for the best matching API is safe to perform, the computer sends a confirmation request to a client device user regarding whether the API call is unsafe to perform. The computer receives a response to the confirmation request from the client device user regarding whether the API call is unsafe to perform. The computer determines whether the response to the confirmation request received from the client device user indicates that the API call is unsafe to perform. In response to the computer determining that the response to the confirmation request received from the client device user does indicate that the API call is unsafe to perform, the computer denies performance of the API call. As a result, illustrative embodiments provide a technical effect of denying performance of an API call in response to determining that a response to a confirmation request received from a client device user indicates that the API call is unsafe to perform.

The computer also receives the user query from a client device user. The computer performs a search of an API database for a set of APIs to achieve the goal of the user query in response to receiving the user query. The API database contains a plurality of API documents and API specifications corresponding to a plurality of different APIs. The computer, using the LLM, ranks the set of APIs based on an ability of each respective API in the set of APIs to achieve the goal of the user query. The computer, using the LLM, selects a top ranking API from the set of APIs as the best matching API to achieve the goal of the user query. The computer, using the LLM, extracts the specific API endpoint and method to achieve the goal of the user query from the best matching API. As a result, illustrative embodiments provide a technical effect of selecting a top ranking API from a set of APIs as a best matching API to achieve a goal of a user query using an LLM and extracting a specific API endpoint and method to achieve the goal of the user query from the best matching API using the LLM.

In addition, the computer retrieves a list of denied API calls in response to performing an API call safety check. The computer compares the API call corresponding to the best matching API to achieve the goal of the user query against the list of denied API calls. The computer determines whether the API call corresponding to the best matching API to achieve the goal of the user query is found in the list of denied API calls. In response to the computer determining that the API call corresponding to the best matching API to achieve the goal of the user query is found in the list of denied API calls, the computer denies performance of the API call. As a result, illustrative embodiments provide a technical effect of denying performance of an API call in response to determining that the API call corresponding to a best matching API to achieve a goal of a user query is found in a list of denied API calls.

Further, in response to the computer determining that the API call corresponding to the best matching API to achieve the goal of the user query is not found in the list of denied API calls, the computer sets an API call safety score associated with the API call corresponding to the best matching API to achieve the goal of the user query to zero. The computer, using the LLM, performs an analysis of the API call corresponding to the best matching API to achieve the goal of the user query. The computer determines whether the API call corresponding to the best matching API to achieve the goal of the user query contains any protected sensitive data based on the analysis performed by the LLM. As a result, illustrative embodiments provide a technical effect of performing an analysis of an API call corresponding to a best matching API to achieve a goal of a user query using an LLM and determining whether the API call corresponding to the best matching API to achieve the goal of the user query contains any protected sensitive data based on the analysis performed by the LLM.

Furthermore, in response to the computer determining that the API call corresponding to the best matching API to achieve the goal of the user query does contain some type of protected sensitive data based on the analysis performed by the LLM, the computer, using the LLM, identifies any of a first type of protected sensitive data and any of a second type of protected sensitive data contained in the API call corresponding to the best matching API to achieve the goal of the user query. The computer increments an API call safety score associated with the API call corresponding to the best matching API to achieve the goal of the user query by a first defined value for any of the first type of protected sensitive data identified in the API call and by a second defined value for any of the second type of protected sensitive data identified in the API call. As a result, illustrative embodiments provide a technical effect of incrementing an API call safety score associated with an API call corresponding to a best matching API to achieve a goal of a user query by a first defined value for any of a first type of protected sensitive data identified in the API call and by a second defined value for any of a second type of protected sensitive data identified in the API call.

Moreover, the computer, using the LLM, predicts a percent probability of data loss resulting from performing the API call corresponding to the best matching API to achieve the goal of the user query. The computer increments the API call safety score associated with the API call corresponding to the best matching API to achieve the goal of the user query by a product of multiplying a third defined value by the percent probability of data loss resulting from performing the API call. As a result, illustrative embodiments provide a technical effect of predicting a percent probability of data loss resulting from performing an API call corresponding to a best matching API to achieve a goal of a user query using an LLM and incrementing an API call safety score associated with the API call by a product of multiplying a third defined value by the percent probability of data loss resulting from performing the API call.

The computer also determines whether the API call safety score associated with the API call corresponding to the best matching API to achieve the goal of the user query is greater than a first API call safety score threshold level. In response to the computer determining that the API call safety score associated with the API call corresponding to the best matching API to achieve the goal of the user query is greater than the first API call safety score threshold level, the computer determines that the API call is unsafe to perform. As a result, illustrative embodiments provide a technical effect of determining that an API call is unsafe to perform in response to determining that an API call safety score associated with the API call corresponding to a best matching API to achieve a goal of a user query is greater than a first API call safety score threshold level.

In addition, in response the computer determining that the API call safety score associated with the API call corresponding to the best matching API to achieve the goal of the user query is not greater than the first API call safety score threshold level, the computer determines whether the API call safety score associated with the API call corresponding to the best matching API to achieve the goal of the user query is between the first API call safety score threshold level and a second API call safety score threshold level. In response to the computer determining that the API call safety score associated with the API call corresponding to the best matching API to achieve the goal of the user query is between the first API call safety score threshold level and the second API call safety score threshold level, the computer sends a confirmation request to a client device user regarding whether the API call is unsafe to perform. As a result, illustrative embodiments provide a technical effect of sending a confirmation request to a client device user regarding whether an API call is unsafe to perform in response to determining that an API call safety score associated with the API call corresponding to a best matching API to achieve a goal of a user query is between a first API call safety score threshold level and a second API call safety score threshold level.

Further, the tool constrains output of the LLM to match the API specification corresponding to the specific API endpoint and method to achieve the goal of the user query. As a result, illustrative embodiments provide a technical effect of constraining output of an LLM to match an API specification corresponding to a specific API endpoint and method to achieve a goal of a user query using a tool.

A computer system comprises a processor set, one or more computer-readable storage media, and program instructions stored on the one or more computer-readable storage media to cause the processor set to perform operations. The computer system retrieves an Application Programming Interface (API) specification corresponding to a specific API endpoint and method extracted from a best matching API to achieve a goal of a user query. The computer system retrieves an API document that supports the API specification corresponding to the specific API endpoint and method to achieve the goal of the user query. The computer system generates a tool for a Large Language Model (LLM) to perform LLM tool calling based on the API specification corresponding to the specific API endpoint and method to achieve the goal of the user query and the API document that supports the API specification. The computer system, using the LLM, invokes the tool to generate an API call corresponding to the best matching API to achieve the goal of the user query. As a result, illustrative embodiments provide a technical effect of generating a tool for an LLM to perform LLM tool calling based on an API specification corresponding to a specific API endpoint and method to achieve a goal of a user query and an API document that supports the API specification, and invoking the tool to generate an API call corresponding to a best matching API to achieve the goal of the user query using the LLM.

In addition, the computer system performs an API call safety check of the API call for the best matching API to achieve the goal of the user query. The computer system determines whether the API call safety check indicates that the API call for the best matching API is safe to perform. In response to the computer system determining that the API call safety check does indicate that the API call for the best matching API is safe to perform, the computer system augments the API call for the best matching API with the authentication information previously removed from the API specification. The computer system executes the tool to perform the API call with the authentication information augmented to call the best matching API to achieve the goal of the user query by retrieving needed information from a remote host device containing the needed information. As a result, illustrative embodiments provide a technical effect of augmenting an API call for a best matching API with authentication information previously removed from an API specification in response to determining that an API call safety check indicates that the API call is safe to perform and executing a tool to perform the API call with the authentication information to call the best matching API to achieve a goal of a user query.

A computer program product comprises one or more computer-readable storage media and program instructions stored on the one or more computer-readable storage media to perform operations. A computer retrieves an Application Programming Interface (API) specification corresponding to a specific API endpoint and method extracted from a best matching API to achieve a goal of a user query. The computer retrieves an API document that supports the API specification corresponding to the specific API endpoint and method to achieve the goal of the user query. The computer generates a tool for a Large Language Model (LLM) to perform LLM tool calling based on the API specification corresponding to the specific API endpoint and method to achieve the goal of the user query and the API document that supports the API specification. The computer, using the LLM, invokes the tool to generate an API call corresponding to the best matching API to achieve the goal of the user query. As a result, illustrative embodiments provide a technical effect of generating a tool for an LLM to perform LLM tool calling based on an API specification corresponding to a specific API endpoint and method to achieve a goal of a user query and an API document that supports the API specification, and invoking the tool to generate an API call corresponding to a best matching API to achieve the goal of the user query using the LLM.

In addition, the computer removes authentication information and other confidential information from the API specification corresponding to the specific API endpoint and method to achieve the goal of the user query to hide the authentication information from the LLM to increase security. As a result, illustrative embodiments provide a technical effect of hiding authentication information from an LLM to increase security by removing the authentication information and other confidential information from an API specification corresponding to a specific API endpoint and method to achieve a goal of a user query.

Further, the computer performs an API call safety check of the API call for the best matching API to achieve the goal of the user query. The computer determines whether the API call safety check indicates that the API call for the best matching API is safe to perform. In response to the computer determining that the API call safety check does indicate that the API call for the best matching API is safe to perform, the computer augments the API call for the best matching API with the authentication information previously removed from the API specification. The computer executes the tool to perform the API call with the authentication information augmented to call the best matching API to achieve the goal of the user query by retrieving needed information from a remote host device containing the needed information. As a result, illustrative embodiments provide a technical effect of augmenting an API call for a best matching API with authentication information previously removed from an API specification in response to determining that an API call safety check indicates that the API call is safe to perform and executing a tool to perform the API call with the authentication information to call the best matching API to achieve a goal of a user query.

Furthermore, the computer receives the needed information corresponding to the goal of the user query from the remote host device in response to executing the API call to the best matching API. The computer filters the needed information corresponding to the goal of the user query received from the remote host device by removing any protected sensitive data from the needed information. The computer sends the needed information corresponding to the goal of the user query with the protected sensitive data removed to a client device user. As a result, illustrative embodiments provide a technical effect of receiving needed information corresponding to a goal of a user query from a remote host device in response to executing an API call to a best matching API, filtering the needed information corresponding to the goal of the user query by removing any protected sensitive data from the needed information, and sending the needed information corresponding to the goal of the user query with the protected sensitive data removed to a client device user.

Moreover, in response to the computer determining that the API call safety check does not indicate that the API call for the best matching API is safe to perform, the computer sends a confirmation request to a client device user regarding whether the API call is unsafe to perform. The computer receives a response to the confirmation request from the client device user regarding whether the API call is unsafe to perform. The computer determines whether the response to the confirmation request received from the client device user indicates that the API call is unsafe to perform. In response to the computer determining that the response to the confirmation request received from the client device user does indicate that the API call is unsafe to perform, the computer denies performance of the API call. As a result, illustrative embodiments provide a technical effect of denying performance of an API call in response to determining that a response to a confirmation request received from a client device user indicates that the API call is unsafe to perform.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

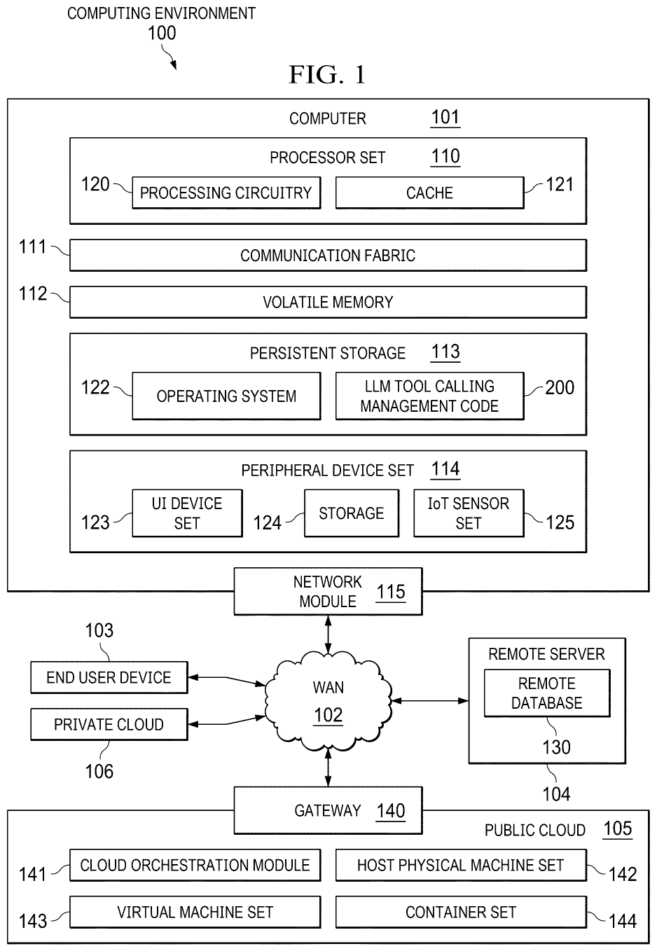

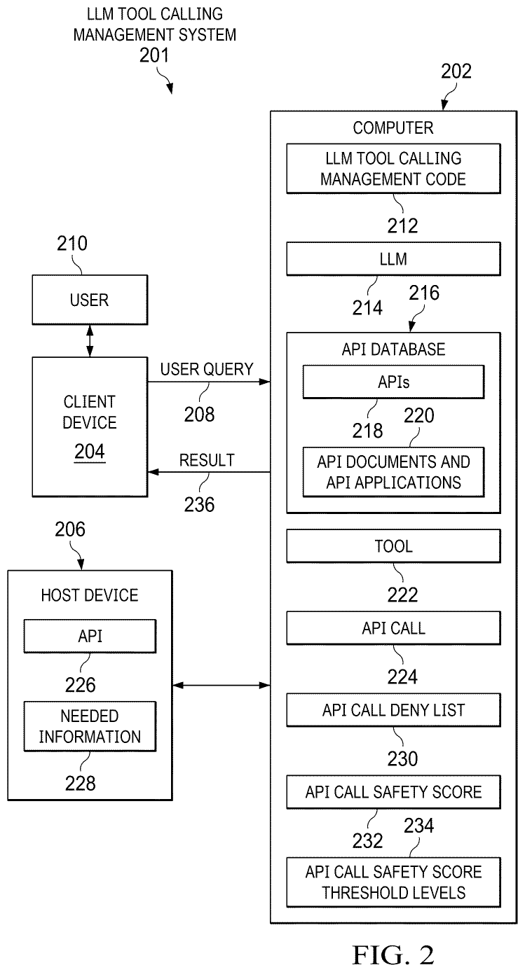

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as Large Language Model (LLM) tool calling management code 200. For example, LLM tool calling management code 200 dynamically generates a single tool for an LLM to call a particular Application Programming Interface (API) to retrieve needed information corresponding to each particular user query received from users.

In addition to LLM tool calling management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and LLM tool calling management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in LLM tool calling management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source portable operating system interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a person who submits user queries to computer 101), and may take any of the forms discussed above in connection with computer 101. EUD 103 typically receives helpful and useful data from the operations of computer 101. For example, in a hypothetical case where computer 101 is designed to provide a query result to the end user, this query result would typically be communicated from network module 115 of computer 101 through WAN 102 to EUD 103. In this way, EUD 103 can display, or otherwise present, the query result to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide responses to user queries, then information needed to respond to the user queries may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A, one of item B, and ten of item C, or four of item B and seven of item C, or other suitable combinations.

The performance or capability of an LLM can be extended by adding tool calling. Tool calling is an ability of an LLM to call an appropriate Application Programming Interface (API) to, for example, obtain current, live, fresh, or accurate data, perform some type of computation, or perform an action. In other words, tool calling is a specific process for LLMs to call particular APIs to retrieve needed information or perform actions corresponding to received user queries.

Currently, when LLMs are used with tool calling, the LLMs can get confused when the number of available tools to call APIs is large, or the tools are complex (e.g., have lots of parameters or have complex parameters). For example, when the number of available tools to call APIs is large, current LLMs often fail to use the appropriate tool to call the correct API to retrieve needed information corresponding to a user query, fail to consistently format API calls, often mix up API call parameters or content, often fail to correctly interpret results received from called APIs, and the like.

Existing solutions depend on and utilize manually authored or created tools to call APIs to ensure effective API calling by these tools. However, using manually authored tools to call APIs limits the capability of LLMs and is difficult to scale to vast numbers of tools.

Existing solutions may also use prompt engineering, possibly in conjunction with multi-shot examples, to improve tool calling reliability. However, using prompt engineering in conjunction with multi-shot examples to improve tool calling reliability may be helpful, but does not scale well to vast numbers of tools.

Existing solutions may also use Java Script Object Notation (JSON) mode in the OpenAI API to constrain the output of LLMs. Using JSON mode to constrain the output of LLMs may be helpful, but does not prevent LLMs from generating tool calls to APIs with the wrong attributes or invalid data in the attributes.

Existing solutions may also decrease the number of tools available by utilizing a search or routing mechanism such that LLMs use only a few or one tool. Using a search or routing mechanism such that calls to APIs by LLMs have only a few or one tool to deal with may be helpful, but does not scale to vast numbers of tools because the tools still must be manually authored.

Illustrative embodiments replace conventional manually built tools for LLM API calling with a single tool that illustrative embodiments dynamically generate for the context of each user query, request, or command. Illustrative embodiments utilize both previous LLM tool calls to specific APIs and conventional code to generate needed tools to call particular APIs corresponding to received user queries based on API documents and API specifications corresponding to those specific APIs called by tools. Illustrative embodiments also perform API call safety checks to decrease risk and increase API calling security and accuracy of tools.

Illustrative embodiments utilize the prompted LLM to determine what information is needed based on analyzing the received user query. However, it should be noted that it is also possible to specifically train an LLM or fine-tune an LLM to do these tasks, reducing the reliance on good prompts. In other words, illustrative embodiments can use a custom trained or fine-tuned LLM instead of the prompt. Illustrative embodiments perform a search (e.g., a retrieval-augmented generation search or the like) of an API database containing a plurality of API documents and API specifications corresponding to a plurality of different APIs by generating a vector (e.g., multidimensional number) using an embedding model. It should be noted that illustrative embodiments cross reference API documents and API specifications to decrease search time. In addition, illustrative embodiments break up or chunk the API documents and API specifications for searching purposes by API endpoint, method, and path. Illustrative embodiments select a best matching API from the plurality of different APIs to retrieve the needed information corresponding to the user query based on the search of the API document and specification database.

Illustrative embodiments use the prompted LLM to extract from the best matching API a specific API endpoint and method to call to retrieve the needed information corresponding to the user query. In addition, illustrative embodiments retrieve the API specification corresponding to the specific API endpoint and method to call to retrieve the needed information associated with the user query. Illustrative embodiments then process the API specification corresponding to the specific API endpoint and method to call to retrieve the needed information associated with the user query by removing authentication information from the API specification corresponding to the specific API endpoint and method to hide the authentication information from the prompted LLM to increase security. It should be noted that conventional code and not the prompted LLM will auto-fill the authentication information. Illustrative embodiments use the prompted LLM to fill in comments for each field in the specific API endpoint and method to call based on an API document that supports the API specification corresponding to the specific API endpoint and method.

Illustrative embodiments configure the prompted LLM for tool calling with a single dynamically generated tool that is based on the API specification and the API document that supports the API specification. The single dynamically generated tool constrains output of the prompted LLM to match the API specification by only sampling tokens that match the API specification. In other words, the single dynamically generated tool only allows the prompted LLM to output information that is needed for the user query. However, it should be noted that alternative illustrative embodiments can dynamically generate two or more tools from the best matching API specifications that illustrative embodiments pass to the prompted LLM. The prompted LLM will then select the preferred tool or tools to call.

Illustrative embodiments utilize the prompted LLM to invoke the single dynamically generated tool to generate an API call for the best matching API to retrieve the needed information corresponding to the user query. Illustrative embodiments perform an API call safety check for the generated API call corresponding to the best matching API. Illustrative embodiments compare the generated API call against a list of allowed and denied API calls based on the specific API endpoint, method, and path corresponding to the best matching API. It should be noted that illustrative embodiments may utilize, for example, pattern matching or the like when comparing a particular API call against the list of allowed and denied API calls.

If illustrative embodiments determine that the generated API call is included in a supplied allowed API call list, then illustrative embodiments assume that the generated API call is safe and do not need to perform further safety checks. If illustrative embodiments determine that the generated API call is listed as a denied API call in the list, then illustrative embodiments determine that the generated API call is unsafe and reject the generated API call. If illustrative embodiments determine that the generated API call is not explicitly denied, then illustrative embodiments perform the safety check and generate an API call safety score for the generated API call based on checking the generated API call for inclusion of protected sensitive data, such as user identification information and secrets, and estimating level of risk of data loss or corruption due to executing the generated API call.

Depending on the generated value of the API call safety score as compared to a defined API call safety score threshold level, illustrative embodiments either reject the generated API call with a reason for the rejection sent back to the user or invoke a human (e.g., system administrator or the like) to determine whether to confirm rejection of the generated API call or proceed with the generated API call. If illustrative embodiments determine that the value of the generated API safety sore is below the defined API safety score threshold level or the human confirmed proceeding with the generated API call, then illustrative embodiments augment the generated API call with the previously removed authentication information and possibly with other system parameters that were previously hidden from the prompted LLM for security reasons. Afterward, illustrative embodiments use the single dynamically generated tool to call the best matching API to retrieve the needed information corresponding to the user query utilizing the generated API call.

Subsequently, illustrative embodiments receive a result corresponding to the user query from the best matching API that retrieved the needed information corresponding to the user query. Illustrative embodiments filter the result corresponding to the user query by removing, for example, any protected sensitive data, secrets, and the like from the result. Illustrative embodiments send the result to the prompted LLM with a prompt to extract the needed information corresponding to the user query from the result. Afterward, illustrative embodiments use the prompted LLM to send the needed information corresponding to the user query to the user.

Thus, illustrative embodiments provide one or more technical solutions that overcome a technical problem with using vast numbers of manually authored tools for LLMs to call APIs to retrieve needed information corresponding to user queries. As a result, these one or more technical solutions provide a technical effect and practical application in the field of LLMs.

With reference now to FIG. 2, a diagram illustrating an example of an LLM tool calling management system is depicted in accordance with an illustrative embodiment. LLM tool calling management system 201 may be implemented in a computing environment, such as computing environment 100 in FIG. 1. LLM tool calling management system 201 is a collection of hardware and software components for dynamically generating a single tool for an LLM to call a specific API to retrieve needed information corresponding to a user query to decrease LLM confusion and increase tool calling accuracy.

In this example, LLM tool calling management system 201 includes computer 202, client device 204, and host device 206. Computer 202 may be, for example, computer 101 in FIG. 1. Client device 204 may be, for example, EUD 103 in FIG. 1. Host device 206 may be, for example, remote server 104 in FIG. 1. However, it should be noted that LLM tool calling management system 201 is intended as an example only and not as a limitation on illustrative embodiments. For example, LLM tool calling management system 201 may include any number of computers, client devices, host devices, and other devices and components not shown. Furthermore, it should be noted that one or more components shown as residing locally in computer 202 may reside remotely in one or more other computers (e.g., servers). For example, in alternative illustrative embodiments LLM 214 and API database 216 may reside remotely instead of locally.

In this example, at 208, user 210 sends a user query to computer 202 via client device 204. Alternatively, user 210 can input the user query directly into compute 202 without using client device 204. Computer 202 includes LLM tool calling management code 212 such as LLM tool calling management code 200 in FIG. 1. In response to computer 202 receiving the user query from user 210, LLM tool calling management code 212 uses LLM 214 to determine what information is needed to respond to the user query based on analyzing the user query.

In response to LLM 214 determining what information is needed to respond to the user query, computer 202 performs a search of API database 216 to identify a best matching API to retrieve the needed information for the user query. For example, computer 202 may perform a vector similarity search based on high dimensional vector embeddings for the user query and the API specification. API database 216 contains APIs 218. APIs 218 represent a plurality of different APIs. API database 216 also contains API documents and API specifications 220. API documents and API specifications 220 represent the documents and specifications that correspond to each of the plurality of different APIs. The API specifications are in a standardized structured format (e.g., OpenAPI specifications or the like). The API documents can be unstructured, such as markdown, but should be linked to the appropriate API specifications.

LLM 214 is prompted to dynamically generate the specification for tool 222 based on the retrieved API specification narrowed down to the single API endpoint and method and the extracted supplemental documentation. Tool 222 then generates API call 224 corresponding to the best matching API to retrieve the needed information for the user query. In this example, the best matching API to retrieve the needed information for the user query is API 226 and the information needed for the user query is needed information 228 located on host device 206.

However, prior to executing API call 224 to call API 226 to retrieve needed information 228, computer 202 determines whether API call 224 is included in API call deny list 230. If computer 202 determines that API call 224 is included in API call deny list 230, then computer 202 denies performance of API call 224. If the computer 202 determines that API call 224 is not included in API call deny list 230, then computer 202 using conventional code generates API call safety score 232 based on whether any protected sensitive data is included with API call 224 and a predicted probability of data loss or corruption associated with performing API call 224.

Computer 202 compares API call safety score 232 against API call safety score threshold levels 234. API call safety score threshold levels 234 include a deny threshold level and a check threshold level. The check threshold level is set lower than the deny threshold level. For example, if computer 202 determines that API call safety score 232 for API call 224 is greater than or equal to the deny threshold level, then computer 202 denies performance of API call 224. If LLM 214 determines that API call safety score 232 for API call 224 is greater than or equal to the check threshold level, then computer 202 checks with the client device user for confirmation prior to performing API call 224. Finally, if computer 202 determines that API call safety score 232 for API call 224 is less than the check threshold level, then computer 202 allows performance of API call 224.

As a result of computer 202 allowing performance of API call 224, tool 222 executes API call 224 to call API 226 to retrieve needed information 228 corresponding to the user query from host device 206. In response to receiving needed information 228 corresponding to the user query, computer 202 processes needed information 228 in accordance with the user query to generate a result for the user query. At 236, computer 202 sends the result for the user query to client device 204 for user 210 to review.

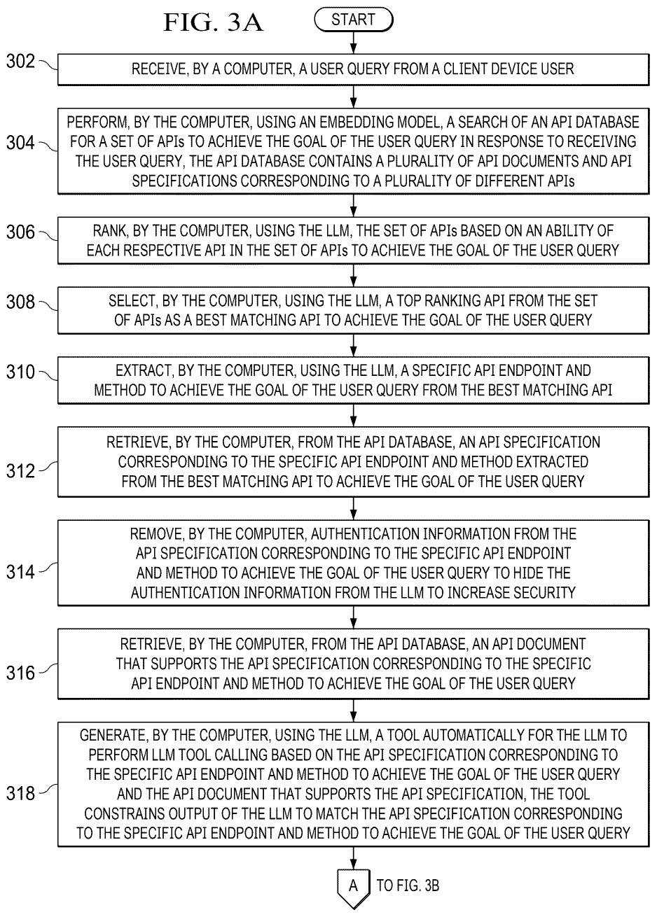

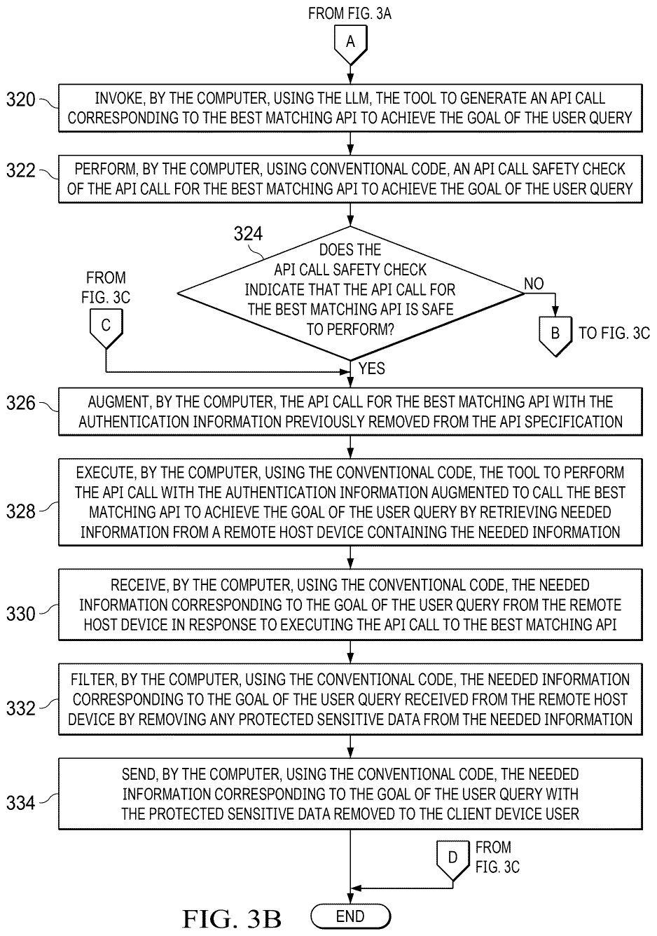

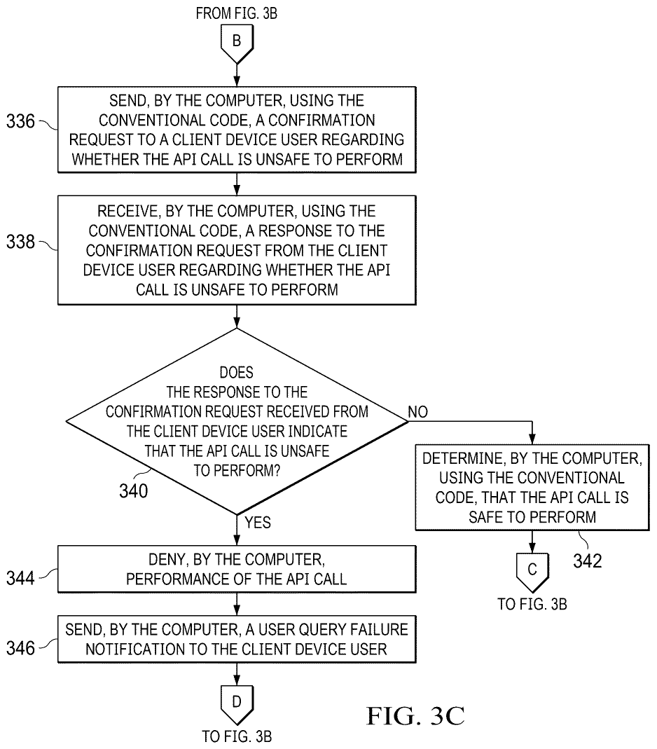

With reference now to FIGS. 3A-3C, a flowchart illustrating a process for managing LLM tool calling is shown in accordance with an illustrative embodiment. The process shown in FIGS. 3A-3C may be implemented in a computer, such as, for example, computer 101 in FIG. 1 or computer 202 in FIG. 2. For example, the process shown in FIGS. 3A-3C may be implemented by LLM tool calling management code 200 in FIG. 1 or LLM tool calling management code 212 in FIG. 2.

The process begins when the computer receives a user query from a client device user (step 302). The computer, using an embedding model, performs a search of an API database for a set of APIs to achieve the goal of the user query in response to receiving the user query (step 304). The API database contains a plurality of API documents and API specifications corresponding to a plurality of different APIs.

The computer, using the LLM, ranks the set of APIs based on an ability of each respective API in the set of APIs to achieve the goal of the user query (step 306). The computer, using the LLM, selects a top ranking API from the set of APIs as a best matching API to achieve the goal of the user query (step 308).

The computer, using the LLM, extracts a specific API endpoint and method to achieve the goal of the user query from the best matching API (step 310). In addition, the computer retrieves from the API database an API specification corresponding to the specific API endpoint and method extracted from the best matching API to achieve the goal of the user query (step 312). The computer removes authentication information from the API specification corresponding to the specific API endpoint and method to achieve the goal of the user query to hide the authentication information from the LLM to increase security (step 314). The computer may also remove other confidential information, such as, for example, an identification number or other information specific to the domain the computer is operating in.

Further, the computer retrieves from the API database an API document that supports the API specification corresponding to the specific API endpoint and method to achieve the goal of the user query (step 316). The computer, using the LLM, automatically generates a tool for the LLM to perform LLM tool calling based on the API specification corresponding to the specific API endpoint and method to achieve the goal of the user query and the API document that supports the API specification (step 318). The tool constrains output of the LLM to match the API specification corresponding to the specific API endpoint and method to achieve the goal of the user query.

The computer, using the LLM, invokes the tool to generate an API call corresponding to the best matching API to achieve the goal of the user query (step 320). Furthermore, the computer, using the LLM, performs an API call safety check of the API call for the best matching API to achieve the goal of the user query (step 322).

The computer makes a determination as to whether the API call safety check indicates that the API call for the best matching API is safe to perform (step 324). If the computer determines that the API call safety check does indicate that the API call for the best matching API is safe to perform, yes output of step 324, then the computer augments the API call for the best matching API with the authentication information previously removed from the API specification (step 326).

Afterward, the computer, using conventional code, executes the tool to perform the API call with the authentication information augmented to call the best matching API to achieve the goal of the user query by retrieving needed information from a remote host device containing the needed information (step 328). Subsequently, the computer, using the conventional code, receives the needed information corresponding to the goal of the user query from the remote host device in response to executing the API call to the best matching API (step 330).

The computer, using the conventional code, filters the needed information corresponding to the goal of the user query received from the remote host device by removing any protected sensitive data from the needed information (step 332). The computer, using the conventional code, sends the needed information corresponding to the goal of the user query with the protected sensitive data removed to the client device user (step 334). Thereafter, the process terminates.

Returning to step 324, if the computer determines that the API call safety check does not indicate that the API call for the best matching API is safe to perform, no output of step 324, then the computer, using the conventional code, sends a confirmation request to the client device user regarding whether the API call is unsafe to perform (step 336). For example, if the computer is about to call a “cancel subscription” API, then the computer may consider this action to be risky enough to check with the client device user to confirm that the client device user really wants to cancel the subscription before proceeding. In other words, the computer wants to confirm that the action about to be performed by the computer is in alignment with the wishes of the client device user. Subsequently, the computer, using the conventional code, receives a response to the confirmation request from the client device user regarding whether the API call is unsafe to perform (step 338).

The computer makes a determination as to whether the response to the confirmation request received from the client device user indicates that the API call is unsafe to perform (step 340). If the computer determines that the response to the confirmation request received from the client device user does not indicate that the API call is unsafe to perform, no output of step 340, then the computer, using the conventional code, determines that the API call is safe to perform (step 342). Thereafter, the process returns to step 326.

If the computer determines that the response to the confirmation request received from the client device user does indicate that the API call is unsafe to perform, yes output of step 340, then the computer denies performance of the API call (step 344). In addition, the computer sends a user query failure notification to the client device user (step 346). Thereafter, the process terminates.

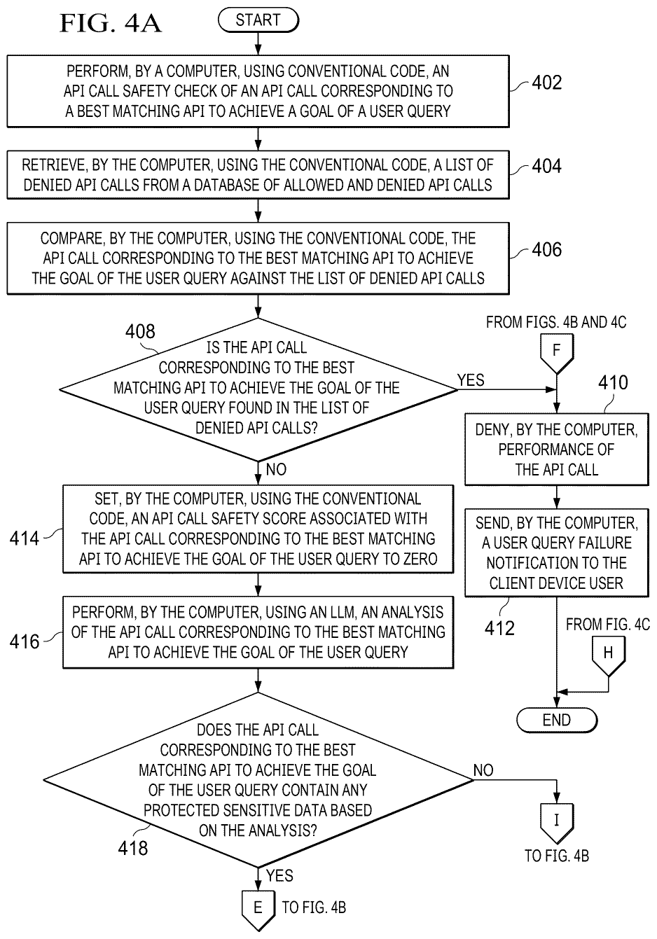

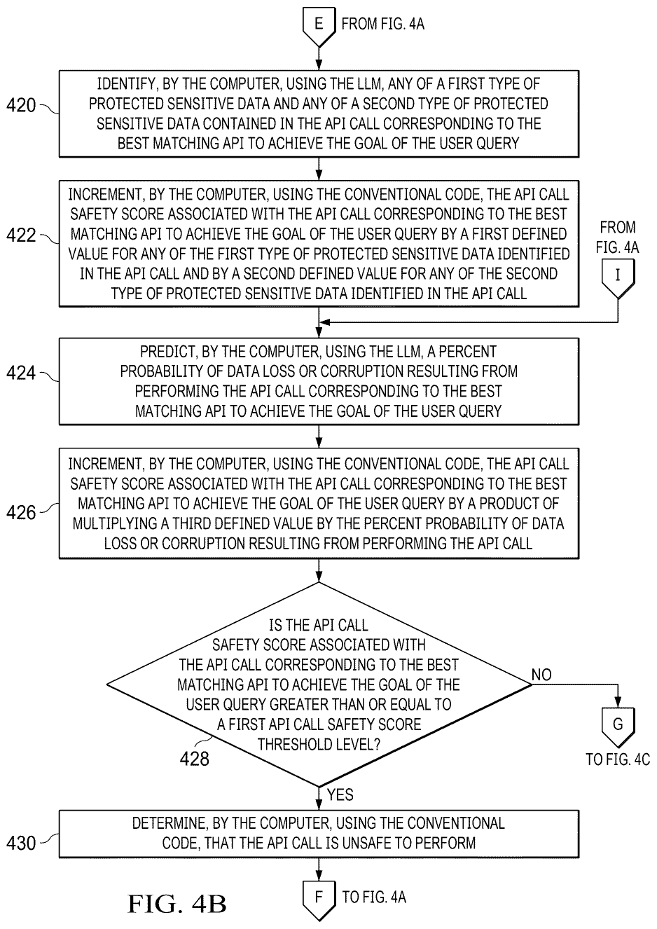

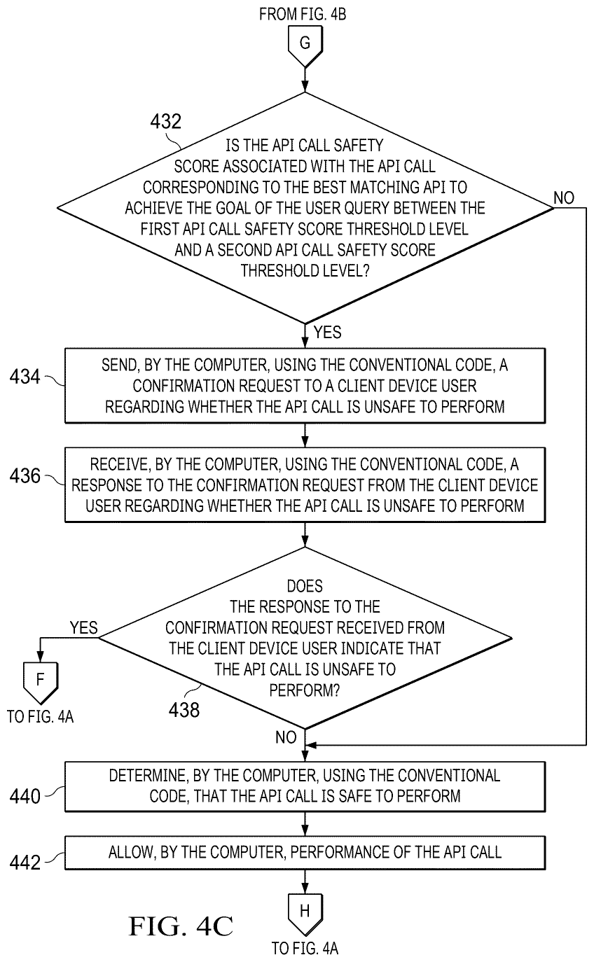

With reference now to FIGS. 4A-4C, a flowchart illustrating a process for performing API call safety checks is shown in accordance with an illustrative embodiment. The process shown in FIGS. 4A-4C may be implemented in a computer, such as, for example, computer 101 in FIG. 1 or computer 202 in FIG. 2. For example, the process shown in FIGS. 4A-4C may be implemented by LLM tool calling management code 200 in FIG. 1 or LLM tool calling management code 212 in FIG. 2.

The process begins when the computer, using an conventional code, performs an API call safety check of an API call corresponding to a best matching API to achieve a goal of a user query (step 402). The computer, using the conventional code, retrieves a list of denied API calls from a database of allowed and denied API calls in response to performing the API call safety check (step 404).

The computer, using the conventional code, compares the API call corresponding to the best matching API to achieve the goal of the user query against the list of denied API calls (step 406). The computer makes a determination as to whether the API call corresponding to the best matching API to achieve the goal of the user query is found in the list of denied API calls (step 408).

If the computer determines that the API call corresponding to the best matching API to achieve the goal of the user query is found in the list of denied API calls, yes output of step 408, then the computer denies performance of the API call (step 410). In addition, the computer sends a user query failure notification to the client device user (step 412). Thereafter, the process terminates.

Returning to step 408, if the computer determines that the API call corresponding to the best matching API to achieve the goal of the user query is not found in the list of denied API calls, no output of step 408, then the computer, using the conventional code, sets an API call safety score associated with the API call corresponding to the best matching API to achieve the goal of the user query to zero (step 414). Further, the computer, using an LLM, performs an analysis of the API call corresponding to the best matching API to achieve the goal of the user query (step 416).

The computer, using the LLM, makes a determination as to whether the API call corresponding to the best matching API to achieve the goal of the user query contains any protected sensitive data based on the analysis (step 418). If the computer determines that the API call corresponding to the best matching API to achieve the goal of the user query does not contain any protected sensitive data based on the analysis performed by the LLM, no output of step 418, then the process proceeds to step 424.

If the computer determines that the API call corresponding to the best matching API to achieve the goal of the user query does contain some type of protected sensitive data based on the analysis performed by the LLM, yes output of step 418, then the computer, using the LLM, identifies any of a first type of protected sensitive data and any of a second type of protected sensitive data contained in the API call corresponding to the best matching API to achieve the goal of the user query (step 420). The computer, using the conventional code, increments the API call safety score associated with the API call corresponding to the best matching API to achieve the goal of the user query by a first defined value for any of the first type of protected sensitive data identified in the API call and by a second defined value for any of the second type of protected sensitive data identified in the API call (step 422).

Moreover, the computer, using the LLM, predicts a percent probability of data loss or corruption resulting from performing the API call corresponding to the best matching API to achieve the goal of the user query (step 424). The computer, using the conventional code, increments the API call safety score associated with the API call corresponding to the best matching API to achieve the goal of the user query by a product of multiplying a third defined value by the percent probability of data loss or corruption resulting from performing the API call (step 426).

The computer makes a determination as to whether the API call safety score associated with the API call corresponding to the best matching API to achieve the goal of the user query is greater than or equal to a first API call safety score threshold level (step 428). If the computer determines that the API call safety score associated with the API call corresponding to the best matching API to achieve the goal of the user query is greater than or equal to the first API call safety score threshold level, yes output of step 428, then the computer, using the conventional code, determines that the API call is unsafe to perform (step 430). Thereafter, the process returns to step 410.

If the computer determines that the API call safety score associated with the API call corresponding to the best matching API to achieve the goal of the user query is not greater than or equal to the first API call safety score threshold level, no output of step 428, then the computer makes a determination as to whether the API call safety score associated with the API call corresponding to the best matching API to achieve the goal of the user query is between the first API call safety score threshold level and a second API call safety score threshold level (step 432). If the computer determines that the API call safety score associated with the API call corresponding to the best matching API to achieve the goal of the user query is not between the first API call safety score threshold level and the second API call safety score threshold level, no output of step 432, then the process proceeds to step 440.

If the computer determines that the API call safety score associated with the API call corresponding to the best matching API to achieve the goal of the user query is between the first API call safety score threshold level and the second API call safety score threshold level, yes output of step 432, then the computer, using the conventional code, sends a confirmation request to a client device user regarding whether the API call is unsafe to perform (step 434). Subsequently, the computer, using the conventional code, receives a response to the confirmation request from the client device user regarding whether the API call is unsafe to perform (step 436).

The computer makes a determination as to whether the response to the confirmation request received from the client device user indicates that the API call is unsafe to perform (step 438). If the computer determines that the response to the confirmation request received from the client device user does indicate that the API call is unsafe to perform, yes output of step 438, then the process returns to step 410.

If the computer determines that the response to the confirmation request received from the client device user does not indicate that the API call is unsafe to perform, no output of step 438, then the computer, using the conventional code, determines that the API call is safe to perform (step 440). The computer allows performance of the API call in response to determining that the API call is safe to perform (step 442). Thereafter, the process terminates.

Thus, illustrative embodiments of the present disclosure provide a computer-implemented method, computer system, and computer program product for dynamically generating a single tool for an LLM to call a specific API to retrieve needed information corresponding to a user query to decrease LLM confusion and increase tool calling accuracy. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
retrieving, by a computer, an Application Programming Interface (API) specification corresponding to a specific API endpoint and method extracted from a best matching API to achieve a goal of a user query;
retrieving, by the computer, an API document that supports the API specification corresponding to the specific API endpoint and method to achieve the goal of the user query;
generating, by the computer, a tool for a Large Language Model (LLM) to perform LLM tool calling based on the API specification corresponding to the specific API endpoint and method to achieve the goal of the user query and the API document that supports the API specification; and
invoking, by the computer, using the LLM, the tool to generate an API call corresponding to the best matching API to achieve the goal of the user query.

2. The method of claim 1, further comprising:
removing, by the computer, authentication information and other confidential information from the API specification corresponding to the specific API endpoint and method to achieve the goal of the user query to hide the authentication information from the LLM to increase security.

3. The method of claim 2, further comprising:
performing, by the computer, an API call safety check of the API call for the best matching API to achieve the goal of the user query;
determining, by the computer, whether the API call safety check indicates that the API call for the best matching API is safe to perform;
responsive to the computer determining that the API call safety check does indicate that the API call for the best matching API is safe to perform, augmenting, by the computer, the API call for the best matching API with the authentication information previously removed from the API specification; and
executing, by the computer, the tool to perform the API call with the authentication information augmented to call the best matching API to achieve the goal of the user query by retrieving needed information from a remote host device containing the needed information.

4. The method of claim 3, further comprising:
receiving, by the computer, the needed information corresponding to the goal of the user query from the remote host device in response to executing the API call to the best matching API;
filtering, by the computer, the needed information corresponding to the goal of the user query received from the remote host device by removing any protected sensitive data from the needed information; and
sending, by the computer, the needed information corresponding to the goal of the user query with the protected sensitive data removed to a client device user.

5. The method of claim 3, further comprising:
responsive to the computer determining that the API call safety check does not indicate that the API call for the best matching API is safe to perform, sending, by the computer, a confirmation request to a client device user regarding whether the API call is unsafe to perform;
receiving, by the computer, a response to the confirmation request from the client device user regarding whether the API call is unsafe to perform;
determining, by the computer, whether the response to the confirmation request received from the client device user indicates that the API call is unsafe to perform; and
responsive to the computer determining that the response to the confirmation request received from the client device user does indicate that the API call is unsafe to perform, denying, by the computer, performance of the API call.

6. The method of claim 1, further comprising:
receiving, by the computer, the user query from a client device user;
performing, by the computer, a search of an API database for a set of APIs to achieve the goal of the user query in response to receiving the user query, the API database contains a plurality of API documents and API specifications corresponding to a plurality of different APIs;
ranking, by the computer, using the LLM, the set of APIs based on an ability of each respective API in the set of APIs to achieve the goal of the user query;
selecting, by the computer, using the LLM, a top ranking API from the set of APIs as the best matching API to achieve the goal of the user query; and
extracting, by the computer, using the LLM, the specific API endpoint and method to achieve the goal of the user query from the best matching API.

7. The method of claim 1, further comprising:
retrieving, by the computer, a list of denied API calls in response to performing an API call safety check;
comparing, by the computer, the API call corresponding to the best matching API to achieve the goal of the user query against the list of denied API calls;
determining, by the computer, whether the API call corresponding to the best matching API to achieve the goal of the user query is found in the list of denied API calls; and
responsive to the computer determining that the API call corresponding to the best matching API to achieve the goal of the user query is found in the list of denied API calls, denying, by the computer, performance of the API call.

8. The method of claim 7, further comprising:
responsive to the computer determining that the API call corresponding to the best matching API to achieve the goal of the user query is not found in the list of denied API calls, setting, by the computer, an API call safety score associated with the API call corresponding to the best matching API to achieve the goal of the user query to zero;
performing, by the computer, using the LLM, an analysis of the API call corresponding to the best matching API to achieve the goal of the user query; and
determining, by the computer, whether the API call corresponding to the best matching API to achieve the goal of the user query contains any protected sensitive data based on the analysis performed by the LLM.

9. The method of claim 8, further comprising:
responsive to the computer determining that the API call corresponding to the best matching API to achieve the goal of the user query does contain some type of protected sensitive data based on the analysis performed by the LLM, identifying, by the computer, using the LLM, any of a first type of protected sensitive data and any of a second type of protected sensitive data contained in the API call corresponding to the best matching API to achieve the goal of the user query; and
incrementing, by the computer, an API call safety score associated with the API call corresponding to the best matching API to achieve the goal of the user query by a first defined value for any of the first type of protected sensitive data identified in the API call and by a second defined value for any of the second type of protected sensitive data identified in the API call.

10. The method of claim 9, further comprising:
predicting, by the computer, using the LLM, a percent probability of data loss resulting from performing the API call corresponding to the best matching API to achieve the goal of the user query; and
incrementing, by the computer, the API call safety score associated with the API call corresponding to the best matching API to achieve the goal of the user query by a product of multiplying a third defined value by the percent probability of data loss resulting from performing the API call.

11. The method of claim 10, further comprising:
determining, by the computer, whether the API call safety score associated with the API call corresponding to the best matching API to achieve the goal of the user query is greater than a first API call safety score threshold level; and
responsive to the computer determining that the API call safety score associated with the API call corresponding to the best matching API to achieve the goal of the user query is greater than the first API call safety score threshold level, determining, by the computer, that the API call is unsafe to perform.

12. The method of claim 11, further comprising:
responsive to the computer determining that the API call safety score associated with the API call corresponding to the best matching API to achieve the goal of the user query is not greater than the first API call safety score threshold level, determining, by the computer, whether the API call safety score associated with the API call corresponding to the best matching API to achieve the goal of the user query is between the first API call safety score threshold level and a second API call safety score threshold level; and
responsive to the computer determining that the API call safety score associated with the API call corresponding to the best matching API to achieve the goal of the user query is between the first API call safety score threshold level and the second API call safety score threshold level, sending, by the computer, a confirmation request to a client device user regarding whether the API call is unsafe to perform.

13. The method of claim 11, wherein the tool constrains output of the LLM to match the API specification corresponding to the specific API endpoint and method to achieve the goal of the user query.

14. A computer system comprising:
a processor set;
one or more computer-readable storage media; and
program instructions stored on the one or more computer-readable storage media to cause the processor set to perform operations comprising:
retrieving an Application Programming Interface (API) specification corresponding to a specific API endpoint and method extracted from a best matching API to achieve a goal of a user query;
retrieving an API document that supports the API specification corresponding to the specific API endpoint and method to achieve the goal of the user query;
generating a tool for a Large Language Model (LLM) to perform LLM tool calling based on the API specification corresponding to the specific API endpoint and method to achieve the goal of the user query and the API document that supports the API specification; and
invoking, using the LLM, the tool to generate an API call corresponding to the best matching API to achieve the goal of the user query.

15. The computer system of claim 14, wherein the operations further comprise:
performing an API call safety check of the API call for the best matching API to achieve the goal of the user query;
determining whether the API call safety check indicates that the API call for the best matching API is safe to perform;
responsive to determining that the API call safety check does indicate that the API call for the best matching API is safe to perform, augmenting the API call for the best matching API with authentication information previously removed from the API specification; and
executing the tool to perform the API call with the authentication information augmented to call the best matching API to achieve the goal of the user query by retrieving needed information from a remote host device containing the needed information.

16. A computer program product comprising:
one or more computer-readable storage media; and
program instructions stored on the one or more computer-readable storage media to perform operations comprising:
retrieving, by a computer, an Application Programming Interface (API) specification corresponding to a specific API endpoint and method extracted from a best matching API to achieve a goal of a user query;
retrieving, by the computer, an API document that supports the API specification corresponding to the specific API endpoint and method to achieve the goal of the user query;
generating, by the computer, a tool for a Large Language Model (LLM) to perform LLM tool calling based on the API specification corresponding to the specific API endpoint and method to achieve the goal of the user query and the API document that supports the API specification; and
invoking, by the computer, using the LLM, the tool to generate an API call corresponding to the best matching API to achieve the goal of the user query.

17. The computer program product of claim 16, wherein the operations further comprise:
removing, by the computer, authentication information and other confidential information from the API specification corresponding to the specific API endpoint and method to achieve the goal of the user query to hide the authentication information from the LLM to increase security.

18. The computer program product of claim 17, wherein the operations further comprise:
performing, by the computer, an API call safety check of the API call for the best matching API to achieve the goal of the user query;
determining, by the computer, whether the API call safety check indicates that the API call for the best matching API is safe to perform;
responsive to the computer determining that the API call safety check does indicate that the API call for the best matching API is safe to perform, augmenting, by the computer, the API call for the best matching API with the authentication information previously removed from the API specification; and
executing, by the computer, the tool to perform the API call with the authentication information augmented to call the best matching API to achieve the goal of the user query by retrieving needed information from a remote host device containing the needed information.

19. The computer program product of claim 18, wherein the operations further comprise:
receiving, by the computer, the needed information corresponding to the goal of the user query from the remote host device in response to executing the API call to the best matching API;
filtering, by the computer, the needed information corresponding to the goal of the user query received from the remote host device by removing any protected sensitive data from the needed information; and
sending, by the computer, the needed information corresponding to the goal of the user query with the protected sensitive data removed to a client device user.

20. The computer program product of claim 18, wherein the operations further comprise:
responsive to the computer determining that the API call safety check does not indicate that the API call for the best matching API is safe to perform, sending, by the computer, a confirmation request to a client device user regarding whether the API call is unsafe to perform;
receiving, by the computer, a response to the confirmation request from the client device user regarding whether the API call is unsafe to perform;
determining, by the computer, whether the response to the confirmation request received from the client device user indicates that the API call is unsafe to perform; and
responsive to the computer determining that the response to the confirmation request received from the client device user does indicate that the API call is unsafe to perform, denying, by the computer, performance of the API call.
